(19) United States
(12) Patent Application Publication
(10) Pub. No.: US 2007/0022015 A1
(43) Pub. Date: Jan. 25, 2007

(54) System and method for the on-line purchase of products through a guest registration

(76) Inventors: Gillian Jetson Tarinelli, Naperville, IL (US); Phillip Lloyd Dunham, Chicago, IL (US); Sunil Sitaula, Chicago, IL (US); Alden Almagro, Chicago, IL (US)

Correspondence Address: WILDMAN HARROLD ALLEN & DIXON, 225 WEST WACKER DRIVE, SUITE 2800, CHICAGO, IL, 60606, US

(21) Appl. No.: 11/187,310

(22) Filed: Jul. 22, 2005

(51) Int. Cl. G06Q 30/00

(52) U.S. Cl. 705/26

(57) ABSTRACT

A computer implemented system and method for providing on-line purchasing of products through a communications network are provided. An application server of the system is adapted to determine that a user is interacting with a website associated with the application server as a guest registrant. A guest processing component residing on the application server obtains information during an on-line purchasing process that is used to establish a member registration account. The member registration account is associated with the user that interacts with the host website as a guest registrant.

### FIELD OF THE INVENTION

The present invention relates to systems and methods that provide for the purchase of travel-related products on-line via a communications network, such as the Internet, and in particular, to such systems and methods that provide for the purchase of travel-related products upon user registration.

### BACKGROUND OF THE INVENTION

Travel-related products such as airline flights, hotel accommodations and automotive rentals are being purchased more and more by consumers through travel-related websites via the Internet. The Internet allows consumers to access vast amounts of data regarding the products and services offered by many different providers.

In conventional systems that offer purchases of travel products to be made on-line, prospective purchasers were required to establish a user account with the host system prior to being permitted to make a purchase via the travel related website. Registration with the host system and the establishment of a user account often required the user to input various information such as an e-mail address, a selected password, home address, credit card information, type of travel (business/leisure), and home airport identification.

Certain travel-related websites also offer a guest registration process. The guest registration process allows a consumer to perform searches and access information relating to travel products that are available to be purchased via the host travel-related website. However, in certain conventional systems, in order for a consumer to actually purchase a travel-related product (such as booking an airline flight or hotel reservation) the consumer may be required to become a registered user and input all the information needed to establish a user account with the host system associated with the travel-related website. Consumers, at times, found this requirement of creating a registration account (and inputting the requested information) with the host system to be time-consuming and undesirable, especially since it disrupted the task of purchasing travel-related products that was being performed. Due to this dissatisfaction with the purchasing process, consumers would periodically abandon the travel product booking (or purchase) rather than go through the registration process to create a membership account. If a consumer does not have the time or the desire to create a registered user account, the consumer may avoid making a purchase via the host system altogether. Therefore, an improved guest registration system is desirable.

### BRIEF DESCRIPTION OF THE DRAWINGS

FIG. 1 is a block diagram of a product purchasing system coupled with a user terminal over a communications network.

FIG. 2 is a flow chart illustrating the steps of on-line registration of a user with the product purchasing system through a guest registration process.

FIG. 3 is an example of a product information page for display at a user terminal.

FIG. 4 is an example of a guest purchaser preferences page for display at a user terminal.

FIG. 5A is an example of a review and purchase page for display at a user terminal.

FIG. 5B is an alternative example of a review and purchase page for display at a user terminal.

FIG. 6 is an example of a purchase confirmation page for display at a user terminal.

FIG. 7 is an example of a member log-in page for display at a user terminal.

### DETAILED DESCRIPTION

A system and method for on-line purchasing of products, such as travel-related products, through a user guest registration process is shown and described. A computer implemented product purchasing system 20 which communicates with a computer controlled user terminal, for example, via a communications network (such as the Internet) establishes an active membership registration account (or updates an existing membership registration account) for users that have accessed the product purchasing system through a guest registration process. In the context of the present specification, “products” may encompass services as well as tangible goods. By way of example only, the present specification describes embodiments related to the on-line search and purchasing and the establishment of member registration accounts concerning travel-related products and, in particular, to hotel accommodations. However, it is understood that the present invention may encompass and apply to various products, on-line product purchasing systems and associated member registration accounts and is intended to be covered by the appended claims and their equivalents.

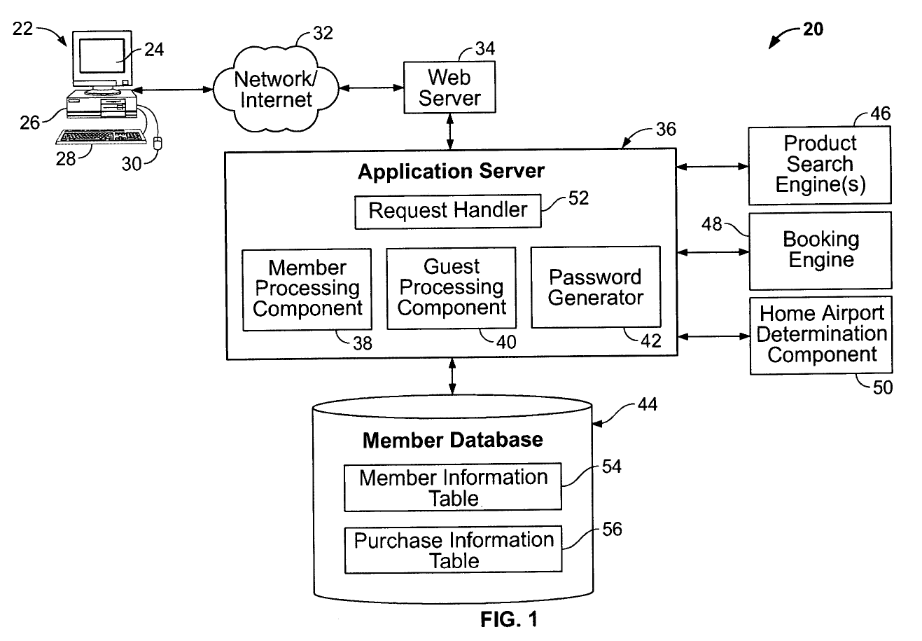

Referring to FIG. 1, a computer implemented system 20 for allowing on-line purchasing of travel-related products through a guest registration process is shown. In this example, system 20 is an Internet based system in which users perform on-line searches and purchase products from their own World Wide Web enabled user terminal 22 having an associated display device 24. User terminal 22, in this embodiment, has display device 24 coupled to a computer controller system 26 and user interface tools such as a keyboard 28, mouse 30, or other devices for inputting data and performing user actions through display device 24. Various types of user terminals may be employed such as desktop computer devices, laptop computer devices, personal digital assistants (PDAs), mobile telephones or any other communication device that may interact with the system 20 over the Internet or alternative communications network. The user terminal 28 includes a web browser program, which will allow a user to communicate over the network 32 such as the Internet (or other communications network) to a network server 34 which returns content back to the user terminal 22 via the Internet. For example, a user desiring to purchase travel-related products may use terminal 22 to contact network server 34 over network 32. Alternative communications networks may also be used such as a LAN (local area network), WAN (wide area network), wireless network, dial-up connection or any other communications network.

Network server 34 may selectively be a dedicated web server adapted to provide a network interface between the user terminal 22 and application server 36 of the system 20. The web server 34 serves web pages of a host website for the system 20 to be displayed at display device 24 of the user terminal 22 in which the web pages are displayed by the web browser running on the user terminal 22. Various commands may also initially be sent by the system 20 to the user terminal 22 to be executed at the user terminal such that certain display operations may be performed at the display device 24 independently of the web server 34 and application server 36. Web server 34 likewise receives input data entered by the user through user terminal 22 and transmitted to the web server 34 over the network 32. Much of the content displayed in the various web pages sent to the user terminal 22 from web server 34 is generated by the product purchasing system 20 based on communications between web server 34 and user terminal 22. However, the processing for generating the content and for carrying out instructions entered at user terminal 22 is performed by the application server 36 and other backend systems which are transparent to the user. The web pages of the host website associated with the application server 36 that are sent to the user terminal 22 are displayed on the display device 24 and form a user interface by which the user interacts with the system 20.

Web server 34 is coupled to application server 36 which acts as an interpreter between the World Wide Web environment of the web server and the user terminal 22, and the backend systems that carry out the core logic and interactive display processes of the computer implemented product purchasing system 20. Backend system components, including application server 36, (having member processing component 38, guest processing component 40, password generator 42 and request handler 52), member database 44, product search engine(s) 46, booking engine(s) 48 and home airport determination component 50 are used in performing processing functions, (such as processing user requests) and generate data which populate web pages sent from web server 34 to user terminal 22. A single server may be used that performs the functions of the web server 34 and application server 36.

Application server 36 is a computer controlled component that manages the translation of user requests to backend system component requests, and stores data that will be used for subsequent user requests. As seen in FIG. 1, member processing component 38, guest processing component 40, and password generator 42 reside on application server 36 in this example. The application server 36 may also have a request handler 52 which interprets requests received from the network 32, determines the appropriate backend system components to serve the requests and routes them accordingly. The member processing component 38, in this example, is a computer software based component that retrieves and stores information associated with a member registration account. This member account information is stored in a member information table 54 in member database 44. The member processing component 38 is adapted to check for the existence of a member account in the member database 44 and may also create a new member account in the member database through a user-directed registration process. The member processing component 38 may also be used to log-in a user having member status to the application server 36. The guest processing component 40, in this example, is a computer software based component that also is adapted to retrieve and store information in member database 44 that is associated with a member registration account. The guest processing component 40 can create member registration accounts through a guest registration process, and is adapted to perform checks to determine whether a user has information stored in the member database 44 without the user explicitly logging-in to the application server 36. Password generator 42 automatically creates a temporary password for transmission via network 32 to users at user terminals 22 that do not have a password or forgot their password.

Member database 44 is coupled with application server 36 and contains various information regarding users that have member registration accounts established within the system 20. Member database 44, in this example, includes a member information table 54 which holds information relating to member registration accounts such as user name and address information, e-mail addresses, encrypted passwords, home and billing addresses, credit card information, user preferences and the like. Member database 44 further includes purchase information table 56 which retains information relating to purchases made by individual users. For instance, for travel-related products, the purchase information table 56 may include itineraries of hotel accommodation bookings, airline flight bookings, or car rental bookings previously made by the user associated with a particular account. Records in the purchase information table 56 are tied to records in the member information table 54 by an identifier or member Id.

One or more product search engines 46 perform searches in response to user product search requests received at the application server 36. The product search engine(s) 46 may include an associated database and rate engine for providing product details and rate information regarding the searched products. The searched products, for example, may include travel-related products such as hotel accommodations, airline flights or car rentals. One or more booking engines 48 coupled with the application server 36 are employed to perform the on-line execution of the purchasing of a selected product. For example, a hotel booking engine may be used for the booking of selected hotel accommodations as a travel-related product. In this example, for hotel accommodation purchases, a hotel booking engine that is a computer based component that coverts user requests for hotel booking purchases into reservation requests for hotel inventory systems may be employed. This type of booking engine, for instance, may connect to hotel inventory systems, make reservations, cancellations and charge a credit card of a user. For the purchasing of travel-related products, a home airport determination component 50 may be employed to determine a home airport that is associated with users having a member registration account with the product purchasing system 20.

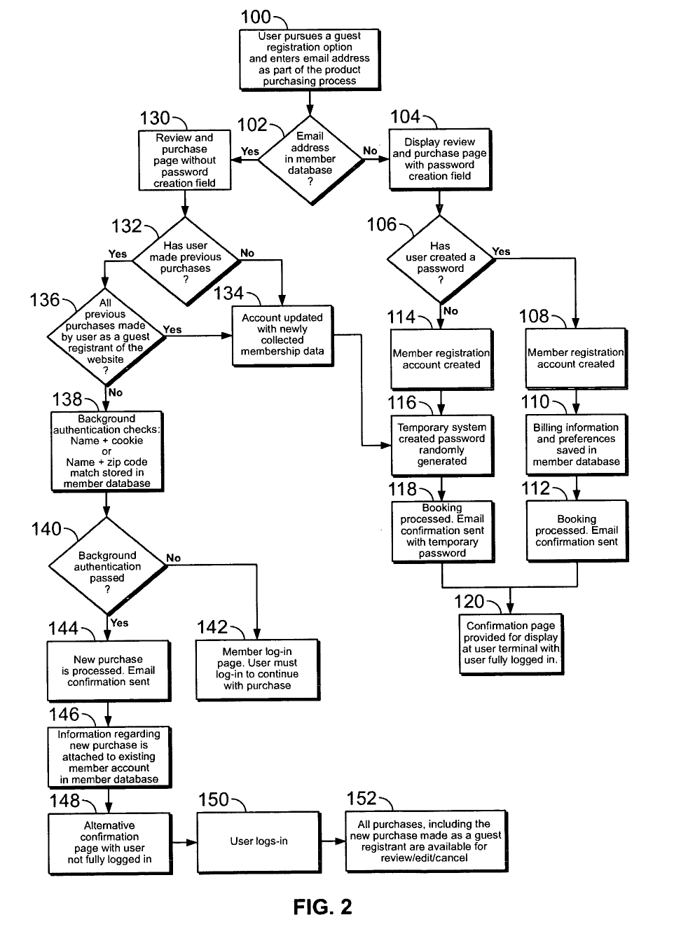

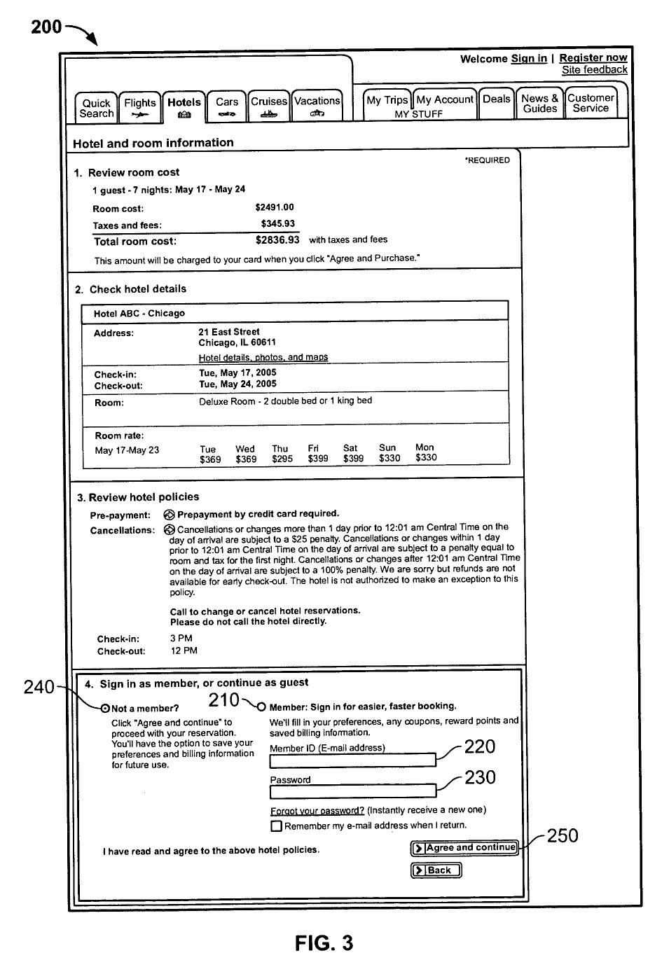

Referring to FIG. 2, in step 100 the user at user terminal 22 interacts with displayed web pages of the website associated with the application server 36 and elects to pursue a guest registration option. In doing so, the user interacts with the host website provided by the application server 36 and web server 34 and may conduct product searching using product search engines 46 and receive product information at the user terminal 22 from web pages displayed via the application server 36 without actually logging-in as an existing member through the member processing component 38. For instance, when the user conducts a product search that is performed by product search engine 46 and decides to make a purchase, a product information page 200, FIG. 3, is displayed and provides the user with the option to sign-in as a website member or continue the on-line purchasing (e.g. hotel, airline or car rental booking) process as a guest registrant. In the example product information page 200, seen in FIG. 3, hotel and room information, such as costs related to the hotel accommodations, duration of the hotel room booking, and hotel details and polices, are provided for display. The product information page 200 provides an option to allow the user to log-in to the system 20 as a member registrant by selecting a “member sign-in” check box 210 and completing a member Id data field 220 and password data field 230. By opting to log-in as a member registrant, processing of user requests is performed by the member processing component 38 of the application server 36.

The product information page 200 also provides the option to allow the user to interact with the host website as a guest registrant by selecting a “not a member” check box 240 and actuating a continue button 250 on the page 200. Upon making this selection and actuation of the continue button 250 the request handler 52 of the application server 36 determines that a member log-in with the host website has not been made and that the user has elected to interact with the host website as a non-member. By selecting the “not a member” option 240, the processing is performed through the guest registration component 40 residing on the application server 36.

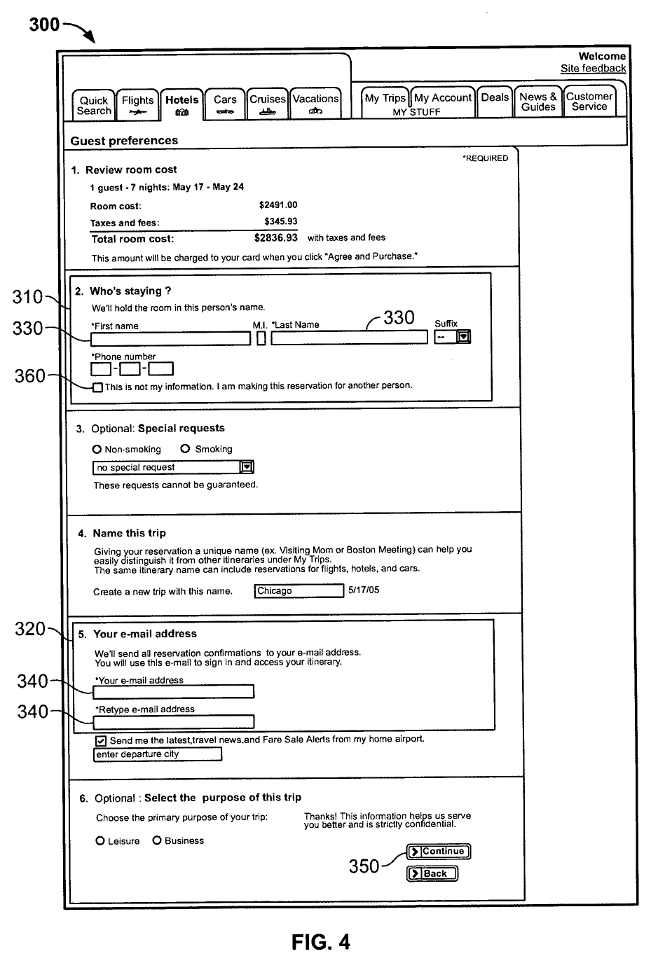

To continue the purchasing process, user selection of the continue button 250 is performed which prompts the application server 36 to display a guest purchaser preferences page 300, FIG. 4. The guest purchaser preferences page 300 has input prompts 310, 320 for the user to input name information in name data field 330 and e-mail address information in e-mail address data field 340. Thus, the user having a guest status enters name and e-mail address information as part of the product purchasing process at the website.

In step 102, FIG. 2, the guest registration component 40 interacts with the existing member database 44 to determine if an e-mail address is stored in the member database 44 that matches the e-mail address obtained by user completion of the e-mail address data fields 340 displayed at user terminal 22. Actuation of continue button 350 transmits the inputted information to the guest processing component 40 of the application server 36. If the inputted e-mail address obtained from the guest user does not match any of the e-mail addresses stored in the member database 44 then the guest processing component 40 determines that the user is a new registrant (e.g. new customer) to the host website. Additionally, if the guest processing component 40 cannot find an existing member registration account in the member information table 54 having an e-mail address that matches the address provided by the user as an inputted “purchase confirmation” e-mail address 340, FIG. 4, then the guest registration component continues with the purchasing process and transparently creates a member registration account associated with the user interacting with the website as a guest registrant.

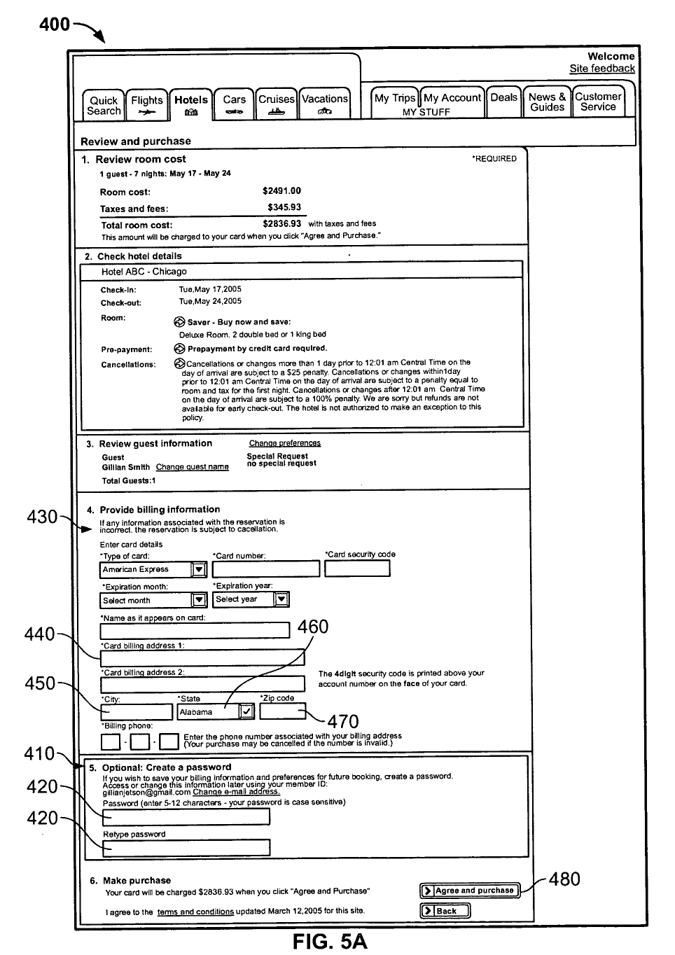

The processing continues to step 104, FIG. 2, in which the application server 36 initiates the display of a review and purchase page 400, FIG. 5A, for display at user display device 24. The review and purchase page 400, FIG. 5A, has a password section 410 with password data fields 420 that provide the user with the option of creating a password. The user may create a password by typing it in password data fields 420. The review and purchase page 400, Fig. SA, also has a billing information section 430 with drop-down menus and data fields for the user to input credit card information including a card billing address data field 440, card billing city data field 450, card billing state data field 460, and card billing zip code data field 470. Upon entering the required information at the review and purchase page 400, the user may review displayed details regarding the product purchase (e.g. purchase of hotel accommodations) and execute an on-line purchase by actuating a purchase select button 480 of the review and purchase page 400.

In step 106, FIG. 2, the guest processing component 40 determines if the user created a password by inserting a password in the password data fields 420, FIG. 5A. If the guest processing component 40 determines that the user did create a password, then in step 108, FIG. 2, the guest processing component establishes a member registration account for the user that has interacted with the website and executed an on-line purchase as a guest registrant. The guest processing component 40 collects information that is obtained during the on-line purchasing process and uses the obtained information to create a member registration account that is associated with the user, having guest status, when making the on-line purchase. For example, the guest processing component 40 collects a user name, e-mail address, and password information provided by the user during the product purchasing process and uses this information to establish the member registration account. For the purchase of hotel accommodations, the member name is obtained from the hotel guest name 330 inputted by the user in the guest preferences page 300, FIG. 4. The user is provided with the option to indicate that the booking is for another person by checking box 360 and the user is then prompted to insert their name. The user is also prompted to enter an e-mail address 340, FIG. 4, in the booking path in order to receive a purchase confirmation e-mail message from the system 20.

A password entered by the user in data field 420 of the review and purchase page 400, FIG. 5A, may also be obtained by the guest processing component 40, FIG. 1, to create the member registration account. Information identifying a home airport for the user may also selectively be used in establishing a member registration account particularly for websites allowing for the purchase of travel-related products. For instance, a home airport determination component 50, FIG. 1, coupled with application server 36 determines a home airport to be associated with the user upon the purchasing of hotel accommodations purchases by obtaining the credit card billing address of the user received from the review and purchase page 400, FIG. 5A, and uses a look up table to translate the city inputted in data field 450 into a relevant airport code. Alternatively, for airfare purchases, the home airport determination component 50, FIG. 1, obtains the origin city entered by the user when performing a search for airline flights and uses a look up table to determine a home airport for the user based on the origin city entered.

The guest processing component 40 extracts this user related information obtained during the purchasing process and sends it to the member information table 54 of the member database 44 to establish a new member registration account. Information related to the purchase made by the user, for example, travel itinerary information for travel-related products, is also provided in the newly created member registration account and stored in the purchase information table 56 of the member database 44. Member registration accounts are stored in the member database 44, and in particular, in the member information table 54, along with other member information such as billing profiles (e.g. billing addresses and credit card information) and member preferences (e.g. preferences to receive or not receive marketing e-mail messages). The purchase information table 56 contains information about purchases made by members. Travel-related purchases, for example, may include itineraries for hotel accommodations, airline flights, and car rentals.

The product purchasing system 20 allows users entering the website as a guest to purchase travel-related products on-line without requiring the user to leave the purchasing segment (e.g. booking path) in order to independently form a separate member registration account by exiting the purchasing path and entering requested account information in a separate member registration sign-up process. At the end of the product purchasing process (For example, an air flight or hotel booking process), the user will be provided with access to their member registration account for the website, with the account being equivalent to one that would be created using a conventional member registration process.

In step 110, FIG. 2, billing information and any preferences information received from the user terminal 22 are sent by the guest processing component 40 to the member information table 54 of the member database 44 to be stored as part of the established member registration account associated with the user. In step 112, the guest processing component 40 of the application server 40 transmits information related to the product purchase request to the booking engine 48 to process the purchase. For example, as seen in FIGS. 3-5A, the product purchase may relate to the booking of hotel room accommodations. An e-mail message confirming the purchase is also sent by the application server 36 to the e-mail address provided by the user in step 112.

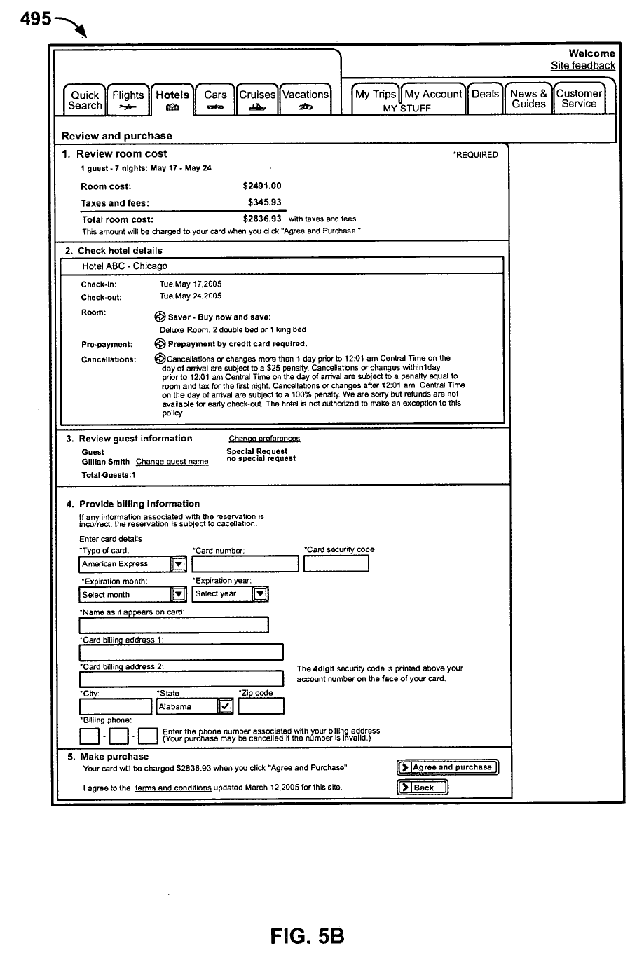

In step 120, FIG. 2, a purchase confirmation page, such as a hotel reservation confirmation page 500 seen in FIG. 6, is provided by the guest processing component 400 of the application server 36 and is displayed at the user terminal 22 with the user being logged-in at the host website. The user at user terminal 22, FIG. 1, receives the purchase confirmation page 500, FIG. 6, that allows for viewing of product purchase details, such as hotel reservation details or travel trip details, by selecting a details link 510. User access to the host website as a logged-in user is also provided. For example, if the user selects a “my account” link 515, the user can view and change information in their associated member registration account such as e-mail addresses, billing information or user preferences.

If in step 106, FIG. 2, the guest processing component 40 determines that a user created password was not received from the user terminal 22, then in step 114, the guest processing component 40 interacts with the member database 44 to create a member registration account as described above in step 108. However, in step 116, password generator 42 automatically creates a system generated password that is assigned to the member registration account if the guest processing component 40 determines that a password was not created by the user in the review and purchase page 400, FIG. 5A. The guest processing component 40, FIG. 1, transmits the system generated password to the e-mail address obtained from the user terminal 22 to permit user access to product purchase information associated with the member registration account.

In step 118, FIG. 2, the guest processing component 40, FIG. 1, transmits information related to the product purchase request to booking engine 48 to process the purchase. For example, booking of hotel room reservations may be performed by booking engine 48. An e-mail message confirming the purchase is sent to the user terminal 22, in step 118, FIG. 2, with the system generated password to the e-mail address provided by the user. The processing continues to step 120, in which the guest processing component 40 provides for the purchase confirmation page 500, FIG. 6, to be displayed at user terminal 22 with the user being logged-in with the host website.

The computer implemented product purchasing system 20 permits a user to complete on-line purchases of products such as hotel accommodations, airline flights, or car rental travel-related products through the communications network 32 even if the user does not have an existing member registration account and interacts with the host website of the system as a guest registrant when making a purchase. The application server 36 is adapted to determine that the user is interacting with the host website as a guest registrant. The guest processing component 40 obtains information received from the user terminal 22 during the on-line purchasing process that is used to establish a member registration account associated with the user having the guest registrant status while interacting with the host website.

The application server 36 is also adapted to determine if a member registration account exists that is associated with the user even though the user has elected to interact with the host website as a guest registrant. If the user desires to execute a new product purchase via the host website, the application server 36 will attach information related to the new purchase, made by the user as a guest registrant, with information regarding prior product purchases stored in the existing member registration account for the user. The application server 36 communicates with booking engine 48 to initiate the processing of the new product purchase via the host website. The guest processing component 40 of application server 36 also determines if the user has made prior product purchases via the host website. The guest processing component 36 identifies an existing member registration account for the user that is stored in the member database 44. The existing member registration account may store information regarding prior product purchases of the user. The guest registration component further provides for the storage of information (e.g. travel itinerary information) regarding the new product purchase made by the user as a guest registrant in the existing member registration account at the member database. The existing member registration account will thus contain prior purchase information of the user as well as information regarding new purchases made by the user as a guest registrant.

In step 102, FIG. 2, if the guest processing component 40 determines that an existing member registration account has an e-mail address that matches the e-mail address provided by the user as a “purchase confirmation” e-mail address in data field 340, FIG. 4, then the processing continues to step 130, FIG. 2, in which the application server 36 initiates the display of an alternative review and purchase page 495, FIG. 5B, that does not have a password creation data field(s) such as those seen in page seen in page 400 of FIG. 5A. The guest registration component 40 determines that the user, although interacting with the host website as a guest, is a prior user (such as an existing customer) of the website and is able to identify an existing member registration account associated with the user as a result of finding a matching e-mail address in the member database 44.

The processing continues to step 132, FIG. 2, in which the guest processing component 40 checks the purchase information table 56, FIG. 1, of the member database 44 to determine if prior purchases have been made via the host website by the user having the existing member registration account. For example, the guest processing component 40 examines the purchase information table 56 to determine if any travel itineraries relating to prior travel-related purchases exist for the member registration account of the user. If the guest processing component 40 determines that the user has not made previous purchases through the host website, then in step 134, FIG. 2, the guest processing component updates the existing member registration account with updated user information, such as newly collected membership data, collected during the on-line purchasing process. Processing continues to step 116, FIG. 2, in which password generator 42 creates a system generated password that is associated with the existing member registration account of the user. The selected product purchase, such as the purchase of hotel accommodations, is booked in step 118.

In step 136, FIG. 2, the guest processing component 40 determines if all previous purchases were made by the user, having an existing member registration account, as a guest registrant of the host website. If the guest processing component 40 determines that all previous purchases were made by the user as a guest, then the processing moves to step 134, FIG. 2, and the existing member registration account is updated with any new membership data obtained from the guest preferences page 300, FIG. 4, or the review and purchase page 400, FIG. 5B, during the one-line purchasing process. If the guest registration component 40 determines, in step 136, that not all prior purchases were made by the user as a guest registrant, then the processing moves to step 138. In step 138, the identity of the user is authenticated. First, the guest processing component 40 determines if data stored in a cookie that was previously placed on the user terminal 22 by the system 20 at the time of the initial membership registration still exists and matches the account for the user. A user name check is also performed by checking for a name match with the existing member registration account stored in the member database 44. If the original cookie exists and a name match is found, the guest processing component 40 will permit the user to continue with the purchasing process without entering a password. If the cookie does not exist on the user terminal 22, then further authentication checks are conducted and the guest processing component 40 will compare user name and billing zip code information inputted by the user during the on-line purchasing process to determine if a match exists in the existing member registration account stored at the member database 44.

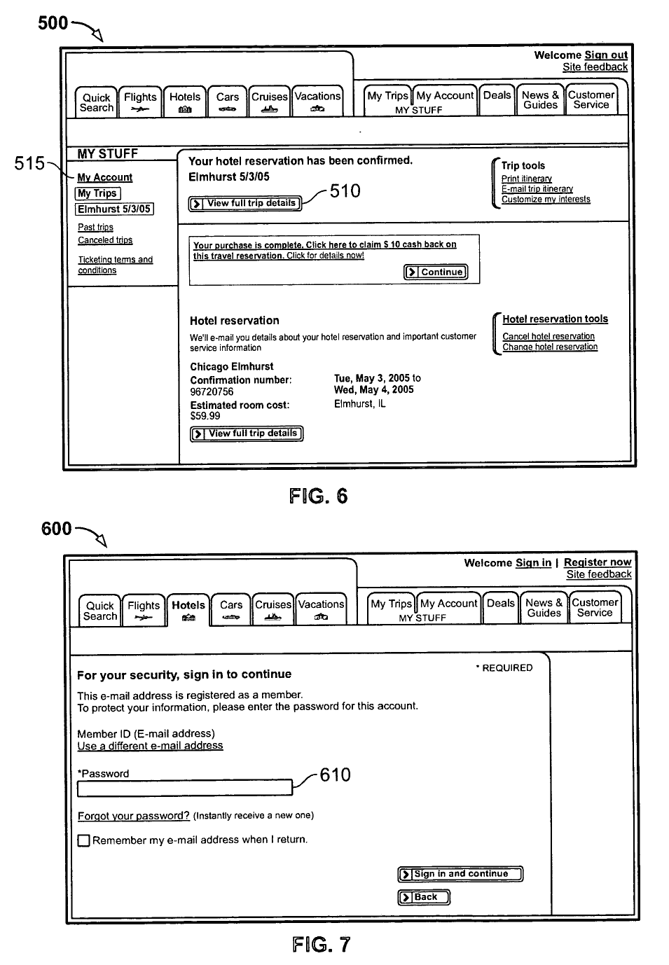

In step 140, the guest processing component 40 determines if the background authentication checks for the user were passed. If the user authentication checks did not pass, then the processing moves to step 142, in which the guest processing component 40 initiates the display of member log-in page 600, FIG. 7. Member log-in page 600 has a password field 610 which prompts the user to input a password. In step 142, FIG. 2, the guest processing component 40, FIG. 1, requires the user to log-in (by inputting correct user name and password data) in order to continue with the on-line purchasing process and to execute purchases, such as booking travel-related products. If in step 140, the guest processing component 40 determines that the user authentication checks have passed, then the processing moves to step 144. In step 144, the new on-line product purchase request of the user having guest status is processed by the booking engine 48 and an e-mail message confirming the product purchase is sent to the e-mail address associated with the existing member registration account for the user.

In step 146, FIG. 2, information regarding the new product purchase made by the user interacting with the host website as a guest registrant during the purchasing process is stored with the existing member registration account associated with the user in the member database 44. The guest processing component 40 links the information obtained regarding the new purchase made by the user, interacting as a guest registrant with the host website, with information previously stored in the purchase information table 56 relating to the prior purchases of the user. Booking and itinerary information for a travel-related purchase, for example, may be attached by the guest processing component 40 to the existing member registration account in the member database 44. Additionally, purchases made via a guest registration process using the guest processing component 40 are recorded as guest purchases in the purchase information table 56. The application server 36 is able to identify member and type of purchases that users have made as guest registrants. In step 148, FIG. 2, the guest processing component 40 provides for the display of a purchase confirmation page at the user terminal 22, however, unlike the purchase confirmation page 500 of FIG. 6, the system 20 will not have the user in a fully logged-in state with the host website. If the user has a purchase history (e.g. travel booking history) that includes purchases made while logged-in with the system 20 as a registered member, then the application server 36 will provide for the display of an alternative purchase confirmation page related to the new purchase made as a guest registrant. A manual log-in including receipt of the correct password for the member registration account will be required, before allowing access to the stored information regarding prior purchases.

In step 150, FIG. 2, if the user desires to see details on prior purchases stored in the existing member registration account, the user may log-in with the application server 36 by entering appropriate name and password information. In step 152, access to information in the member registration account regarding all documented purchases made by the user, including the new product purchase made as a guest registrant, is made available by the guest processing component 40 for review, editing or cancellation by the user. For example, a user having completed a travel trip purchase through the system 20 as a guest registrant may log-in and have access to the trip itinerary for the recent purchase as well as trip itineraries for prior purchases made by the user under the existing member registration account. The application server 36 allows the logged-in user to edit or cancel any travel trip purchases (such as modifying hotel accommodation or airfare purchases, in this example) that are desired by the user.

The foregoing description of the preferred embodiments of the invention have been presented for purposes of illustration and description, and are not intended to be exhaustive or to limit the invention to the precise forms disclosed. The descriptions were selected to best explain the principles of the invention and their practical application to enable other skills in the art to best utilize the invention in various embodiments and various modifications as are suited to the particular use contemplated. It is intended that the scope of the invention not be limited by the specification, but be defined by the claims set forth below.

What is claimed is:

1. A computer implemented method for providing on-line purchasing of products through a communications network comprising:
determining that a user at a user terminal is interacting with a host website as a guest registrant;
collecting information during an on-line purchasing process that is used to establish a member registration account; and
associating the member registration account with the user that is interacting with the host website as a guest registrant.

2. The method of claim 1 further comprising permitting an on-line product purchase to be made by the user as the guest registrant via the host website.

3. The method of claim 2 in which the step of permitting an on-line product purchase further comprises permitting the purchase of products to be completed without requiring a separate member registration account to be created during a member registration process.

4. The method of claim 2 in which the step of determining further comprises determining that the user has elected to interact with the host website as a non-member.

5. The method of claim 2 in which the step of determining further comprises determining that a member log-in with the host website has not been made.

6. The method of claim 2 in which the products include travel-related products.

7. The method of claim 6 in which the travel-related products include at least one of: (a) hotel accommodations, (b) airline flights, and (c) car rentals.

8. The method of claim 7 in which the step of collecting information further includes obtaining name and e-mail address information associated with the user.

9. The method of claim 8 further comprising determining if the user has created a password; and
automatically providing a system generated password assigned to the member registration account associated with the user if the password has not been created by the user.

10. The method of claim 9 further comprising transmitting the system generated password to the e-mail address obtained to permit user access to purchasing information associated with the member account registration of the user interacting with the host website as the guest registrant.

11. The method of claim 8 further comprising determining if the user is a new registrant to the host website by determining that the e-mail address obtained does not match any e-mail addresses stored in a member database.

12. A computer implemented system for providing on-line purchases of products through a communications network comprising:
an application server adapted to determine that a user at a user terminal is interacting with a host website as a guest registrant; and
a guest processing component associated with the application server that is adapted to obtain information during an on-line purchasing process that is used to establish a member registration account that is associated with the user having guest registrant status during the interaction with the host website.

13. The system of claim 12 in which the application server permits an on-line product purchase to be made via the host website by the user having guest registrant status.

14. The system of claim 13 in which the application server allows the user to complete the on-line product purchase without requiring a separate member registration account to be created through a member processing component during a member registration process.

15. The system of claim 12 further comprising a member processing component of the application server adapted to process member requests and in which a request handler of the application server is adapted to determine whether a member log-in with the host website has been made.

16. The system of claim 12 in which the application server is adapted to determine that the user has elected to interact with the host website as a non-member.

17. The system of claim 16 in which the application server routes user requests to the guest processing component in response to determining that the user has elected to interact with the host website as a non-member.

18. The system of claim 12 in which the products include travel-related products.

19. The system of claim 18 in which the travel related products include at least one of: (a) hotel accommodations, (b) airline flights, and (c) car rentals.

20. The system of claim 19 in which the guest processing component obtains name and e-mail address information associated with the user in order to establish the member registration account.

21. The system of claim 20 further comprising a member database coupled with the application server in which the member database has a member information table and a purchase information table that store information for the member registration account.

22. The system of claim 21 in which the member information table stores member registration account information and the purchase information table stores travel itinerary information.

23. The system of claim 20 further comprising a password generator that automatically provides a system generated password assigned to the member registration account if the guest processing component determines that a password was not created by the user.

24. The system of claim 23 in which the guest processing component transmits the system generated password to the e-mail address obtained to permit user access to purchasing information associated with the member registration account.

25. The system of claim 20 in which the guest processing component compares the email address obtained from the user to e-mail addresses stored in a member database to determine if a match exists.

26. The system of claim 20 further comprising a home airport determination component that utilizes a look up table to determine a home airport to be associated with the user based on city information received at the application server.

27. A computer implemented method of providing on-line purchasing of products through a communications network comprising:
determining that a user at a user terminal is interacting with a host website as a guest registrant;
determining if the user has made prior product purchases via the host website;
processing a new product purchase of the user as the guest registrant during an on-line purchasing process with the host website;
identifying an existing member registration account associated with the user in which the existing member registration account has stored information regarding prior product purchases of the user; and
storing information regarding the new product purchase made by the user as the guest registrant in the existing member registration account associated with the user.

28. The method of claim 27 further comprising authenticating the identity of the user.

29. The method of claim 28 further comprising determining if data stored in a cookie residing on the user terminal matches data stored in the existing member registration account for the user.

30. The method of claim 28 further comprising comparing information stored in a member database with information inputted by the user during the on-line purchasing process to determine if a match exists.

31. The method of claim 30 in which the step of comparing further comprises comparing user name and billing zip code information.

32. The method of claim 28 in which the step of identifying the existing member registration account further comprises the step of determining that an e-mail address received from the user terminal matches an e-mail address stored in a member database.

33. The method of claim 32 in which the step of determining that the user is interacting with the host website further comprises determining that a member login with the host website has not been made.

34. The method of claim 32 in which the step of determining that the user is interacting with the host website further comprises determining that the user has elected to interact with the host website as a non-member.

35. The method of claim 32 further comprising the step of permitting completion of the new product purchase without requiring receipt of a password from the user terminal.

36. The method of claim 35 in which the products include travel-related products.

37. The method of claim 36 in which the travel-related products include at least one of: (a) hotel accommodations, (b) airline flights, and (c) car rentals.

38. The method of claim 37 further comprising updating the existing member registration account with user account information collected during the purchasing process upon a determination that the user has not made previous purchases via the host website.

39. The method of claim 38 further comprising providing user access to the stored information regarding the prior product purchases and the new product purchase upon receipt of a confirming password for the member registration account.

40. The method of claim 39 in which the stored information includes travel itinerary information stored at a purchase information table of the member database.

41. A computer implemented system for providing on-line purchasing of products through a communications network comprising:
an application server adapted to determine that a user at a user terminal is interacting with a host website as a guest registrant and to initiate processing of a new product purchase during an on-line purchasing process with the host website;
a guest processing component, associated with the application server, adapted to determine if the user has made prior product purchases via the host website; and
a member database coupled with the application server that stores member registration accounts in which the guest processing component is adapted to identify an existing member registration account associated with the user, the existing member registration account has stored information regarding prior product purchases of the user, and the member database stores information regarding the new product purchase made by the user as a guest registrant in the existing member registration account.

42. The system of claim 41 in which the guest processing component performs checks to authenticate an identity of the user.

43. The system of claim 42 in which the guest processing component is adapted to determine if data stored in a cookie residing on the user terminal matches data stored in the existing member registration account for the user.

44. The system of claim 42 in which the guest processing component compares user name and zip code billing information stored in the existing member registration account with user name and zip code billing information inputted by the user during the on-line purchasing process to determine if a match exists.

45. The system of claim 41 in which the application server is adapted to determine if an email address received from the user terminal matches an email address stored in the member database.

46. The system of 45 in which the guest processing component allows for completion of the new product purchase without requiring receipt of a password from the user terminal.

47. The system of claim 45 in which the products include travel-related products.

48. The system of claim 47 in which the travel-related products include at least one of: (a) hotel accommodations, (b) airline flights, and (c) car rentals.

49. The system of claim 48 in which the guest processing component is adapted to update a member information table of the member database with user account information collected during the purchasing process if the guest processing component determines that previous purchases have not been made via the host website by the user.

50. The system of claim 49 in which the guest processing component provides for user access to the stored information regarding the prior product purchases and the new product purchase in the member database upon receipt of a confirming password for the member registration account.

51. The system of claim 50 in which the stored information includes travel itinerary information stored at a purchase information table of the member database.
